(19) United States
(12) Patent Application Publication
(10) Pub. No.: US 2014/0222607 A1
(43) Pub. Date: Aug. 7, 2014

(54) Systems and Methods for Distributing Limited Edition Digital Artwork

(71) Applicant: Sedition Art, Anaheim, CA (US)

(72) Inventors: Sylvio Drouin, San Francisco, CA (US); Harry Blain, Anaheim, CA (US)

(73) Assignee: Sedition Art, Anaheim, CA (US)

(21) Appl. No.: 14/174,793

(22) Filed: Feb. 6, 2014

Related U.S. Application Data
(60) Provisional application No. 61/761,332, filed on Feb. 6, 2013.
(60) Provisional application No. 61/761,856, filed on Feb. 7, 2013.
(60) Provisional application No. 61/772,075, filed on Mar. 4, 2013.
(60) Provisional application No. 61/824,999, filed on May 18, 2013.

(51) Int. Cl. G06Q 30/06

(52) U.S. Cl. CPC G06Q 30/0643; G06Q 30/0633
USPC 705/26.3; 705/26.25

(57) ABSTRACT

Systems and methods for distributing limited edition digital artwork in accordance with embodiments of the invention are disclosed. In one embodiment, a digital art gallery server system includes a digital edition distribution server that includes a plurality of files containing digital artworks; a digital edition database containing data describing the digital artworks, a plurality of user accounts, the digital artworks specific user accounts are authorized to access, associations between digital edition entries referencing specific digital artworks and specific user accounts; and a digital edition management server configured to generate a limited number of digital edition entries referencing the digital artworks, generate a user interface that includes information regarding at least one digital edition for sale, associate a specific digital edition entry in the digital edition database with a specific user account upon the sale of each digital edition reflecting a chain of title indicating ownership to the sold digital edition.

### CROSS-REFERENCE TO RELATED APPLICATIONS

The current application claims priority to Provisional Patent Application Nos.: 61/761,332 filed Feb. 6, 2013, 61/761,856 filed Feb. 7, 2013, 61/772,075 filed Mar. 4, 2013, and 61/824,999 filed May 18, 2013, the disclosures of which are incorporated herein by reference.

### FIELD OF THE INVENTION

The present invention generally relates to digital artwork and more specifically to systems and methods for the distribution of limited edition digital artwork.

### BACKGROUND

An artist can create artworks to express their observations and contemplations utilizing various methods and mediums. To name a few, artworks can include paintings, photographs, sculptures, music, and film. Traditionally, art is presented to a viewing audience in a physical space such as an art gallery, however, online art collections and museums with web presences allow viewers to enjoy art via the Internet. Today, art can also include digital artworks that showcase various forms of digital multimedia by utilizing digital technology.

### SUMMARY OF THE INVENTION

Systems and methods for distributing limited edition digital artwork in accordance with embodiments of the invention are disclosed. In one embodiment, a digital art gallery server system includes a digital edition distribution server including a processor and a memory including a digital edition distribution server application and a plurality of files containing digital artworks where the digital edition distribution server application configures the processor to receive a request to access at least one file containing a digital artwork from a user and transmit data within the at least one file containing the digital artwork to the user; a digital edition database containing data describing the digital artworks stored on the digital edition distribution server, a plurality of user accounts, the digital artworks specific user accounts are authorized to access, associations between digital edition entries referencing specific digital artworks and specific user accounts; a digital edition management server configured to communicate with the digital edition distribution server including a processor, a memory containing a digital edition management server application, where the digital edition management server application configures the processor to generate a limited number of digital edition entries within the digital edition database referencing the digital artworks stored in the digital distribution server, where each digital edition entry in the digital edition database includes an edition number that uniquely identifies each digital edition, generate a user interface that includes information regarding at least one digital edition for sale, where the user interface allows the digital edition management server to receive a request to purchase the at least one digital edition for sale, associate a specific digital edition entry in the digital edition database with a specific user account upon the sale of each digital edition reflecting a chain of title indicating ownership to the sold digital edition, identify at least one digital artwork that a specific user account is authorized to access from the data describing the digital artworks specific user accounts are authorized to access in the digital edition database, and generate a user interface that provides information for requesting access to at least one file containing the digital artwork.

In a further embodiment, the digital edition database utilizes a relational data model.

In another embodiment, the digital edition management server application also configures the processor to receive log-in credentials and authenticate the log-in credentials with the plurality of user accounts stored in the digital edition database.

In a still further embodiment, the digital edition management server application also configures the processor to generate a user interface that includes information regarding at least one digital edition for resale, where the user interface allows the digital edition management server to receive a request to purchase the at least one digital edition for resale.

In still another embodiment, the resale of the at least one digital edition further includes confirming that all the generated limited number of digital edition entries referencing the specific digital artwork have been associated with specific user accounts.

In a yet further embodiment, the resale of the at least one digital edition includes an auction process, where the auction process comprises receiving at least one bid via the user interface to purchase the at least one digital edition for resale.

In yet another embodiment, the digital edition database further includes data describing associations between digital edition entries referencing specific digital artworks and specific user accounts forming chains of title for the specific digital editions and the digital edition management server application further configures the processor to associate a specific digital edition entry in the digital edition database with a specific user account upon the resale of each digital edition reflecting a chain of title to the resold digital edition.

In a further embodiment again, the digital edition database further includes data describing rental permissions with respect to specific digital edition entries and specific user accounts and the digital edition management server application further configures the processor to receive a rental request to access at least one file containing a digital artwork.

In another embodiment again, the digital edition management server application further configures the processor to conduct a financial transaction that provides credits to the user account associated with the digital edition entry granted rental permissions.

In a further additional embodiment, the digital edition management server application further configures the processor to determine an amount to credit to the user account associated with the digital edition entry granted rental permissions and an amount to credit an account associated with the digital art gallery server system, where the account associated with the digital art gallery server system is stored in the digital edition database.

In another additional embodiment, the data describing the digital artworks specific user accounts are authorized to access is the associations between digital edition entries referencing specific digital artworks and specific user accounts.

### BRIEF DESCRIPTION OF THE DRAWINGS

FIG. 1 is a system diagram of a digital art gallery server system in accordance with an embodiment of the invention.

FIG. 2 illustrates a digital edition management server in accordance with an embodiment of the invention.

FIG. 3 illustrates a digital artwork distribution server in accordance with an embodiment of the invention.

FIG. 4 illustrates an artwork viewing device in accordance with an embodiment of the invention.

FIG. 5 is a flow chart illustrating a process for distributing limited edition digital artworks in accordance with an embodiment of the invention.

FIG. 6 is a flow chart illustrating a process for generating limited digital editions of a digital artwork in accordance with an embodiment of the invention.

FIG. 7A is a flow chart illustrating the sale of a digital edition in accordance with an embodiment of the invention.

FIG. 7B is a screen shot of a listing screen that can be utilized in the sale of a digital edition in accordance with an embodiment of the invention.

FIG. 8A is a flow chart illustrating the resale of a digital edition in accordance with an embodiment of the invention.

FIG. 8B is a screen shot of a listing screen that can be utilized in the resale of a digital edition in accordance with an embodiment of the invention.

### DETAILED DESCRIPTION OF THE DRAWINGS

Turning now to the drawings, systems and methods for distributing limited edition digital artworks in accordance with embodiments of the invention are illustrated. In many embodiments, digital artwork is created by artists using various digital technologies as part of a creative and/or performance process. The digital artwork can comprise digital data and/or be created using digital techniques customarily used by artists that work with digital media. In various embodiments, the digital artwork is uploaded to a digital art gallery server system and presented to the public using websites, mobile applications, and/or any other appropriate platform for presenting digital content via the Internet.

The digital art gallery server system can include a digital edition management server that manages the right to access the digital artwork. In many embodiments, the digital edition management server distributes digital artworks by generating a limited quantity of digital editions of the uploaded digital artwork. In a variety of embodiments, the digital editions are sold to registered users who can resell purchased digital editions to other registered users. The distribution of limited edition digital artworks can also include the downloading, streaming, and/or renting out (i.e. temporary grant of rights to another registered user) of digital artworks utilizing a digital artwork distribution server. In various embodiments, the digital art gallery server system also includes a secure digital edition database that stores information regarding (but not limited to) registered users, artists, uploaded artworks, digital editions, sale and resale of digital editions, and/or certificates of authenticity. Access to limited edition digital artwork can be controlled by maintaining a record within the digital edition database that identifies the registered user holding the rights associated with ownership of each digital edition. In many embodiments, a chain of title can be generated and/or updated to identify current and/or past registered users having rights associated with ownership of a digital edition using information stored on the digital edition database. Although it may be possible to create unauthorized copies of a digital artwork, the sale of such copies via the digital art gallery server system can be prevented because the digital edition database serves to establish a chain of title and to authenticate users prior to any sale or resale of digital editions of digital artworks.

### Digital Art Gallery Server Systems

Digital art gallery server systems typically include digital edition management servers that manage the right to access a digital artwork using information stored in digital edition databases. Working in conjunction with digital edition management servers, digital artwork distribution servers can distribute digital artwork to a multitude of artwork viewing devices that are connected to the digital art gallery server systems via the Internet.

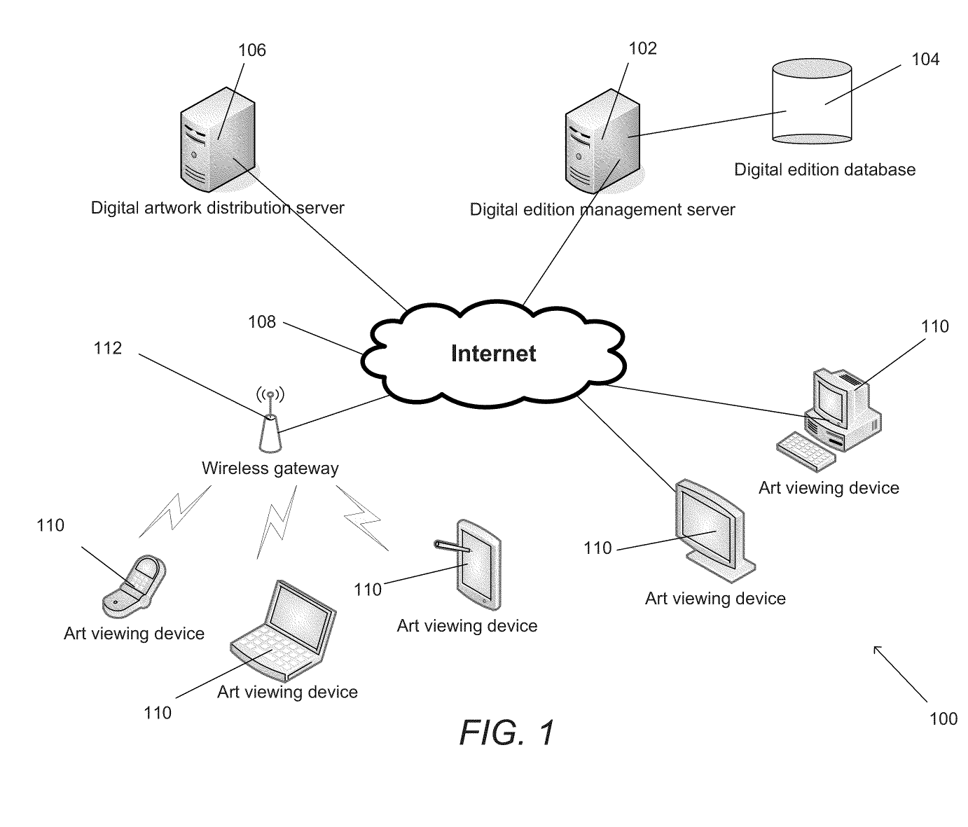

A digital art gallery server system in accordance with an embodiment of the invention is illustrated in FIG. 1. The system 100 includes a number of artwork viewing devices 110 that connect to a digital edition management server 102 and a digital artwork distribution server 106 via the Internet 108. In various embodiments, some artwork viewing devices 110 communicate wirelessly with a cellular data network 112 (i.e. wireless gateway) to connect to the Internet 108. In many embodiments, the digital edition management server 102 is connected to a digital edition database 104 that stores information utilized to determine the right to access a digital artwork as further discussed below. In some embodiments, the digital edition database 104 can be maintained on a storage device within the digital edition management server 102 or maintained within a separate database.

In many embodiments, the digital edition database stores information regarding (but not limited to) users, artists, uploaded artworks, digital editions, certificates of authenticity, and/or chain of titles to digital editions. In various embodiments, access to limited edition digital artwork is controlled by the digital edition management server by authenticating registered users and/or confirming chain of titles prior to any sale or resale of digital editions using information stored in the digital edition database. The digital edition management server can also use the information stored in the digital edition database to grant access to view, download, and/or stream the limited edition digital artworks. In many embodiments, the digital edition management server can provide instructions to the digital artwork distribution server to coordinate the downloading and/or streaming of the digital artwork by a registered user for viewing on various art viewing devices.

Although specific digital art gallery server systems for distributing limited edition digital artwork are discussed above with respect to FIG. 1, any of a variety of digital art gallery server systems for distributing limited edition digital artworks as appropriate to the requirements of a specific application can be utilized in accordance with embodiments of the invention. Configurations of servers and artwork viewing devices in accordance with embodiments of the invention are discussed further below.

### Server and Artwork Viewing Device Configurations

Digital edition management servers in accordance with embodiments of the invention can manage the right to access digital artwork using data stored on digital edition databases. In many embodiments, digital edition databases utilize a relational model where data is stored and organized using a collection of tables where each data item in a table can be identified by the attribute (i.e. column) and tuple (i.e. row) within the table and a plurality of tables can have defined relationships with each other. In other embodiments, any of a variety of database storage techniques can be utilized to organize data describing digital artwork. Digital edition databases in accordance with many embodiments of the invention organize large amounts of data and allow digital edition management servers to query the database in managing access rights.

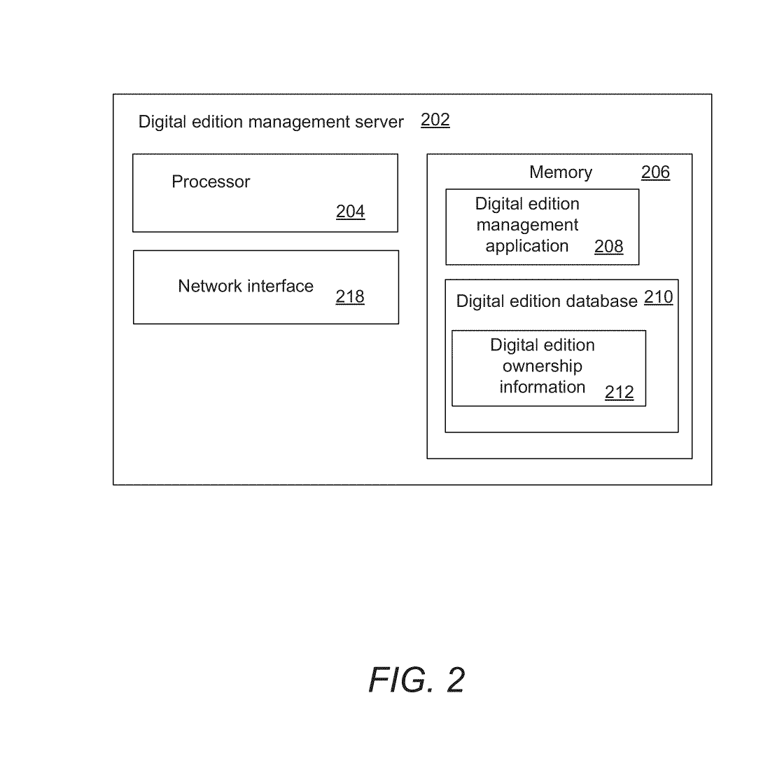

A digital edition management server in accordance with an embodiment of the invention is illustrated in FIG. 2. The digital edition management server 202 includes a processor 204 and a memory 206 that includes a digital edition management application 208. The digital edition management application 208 is utilized to configure the processor 204 to perform various functions including (but not limited to) uploading a digital artwork to the digital art gallery server system and generating digital editions of the uploaded digital artworks as further discussed below. In many embodiments, the memory 206 includes a digital edition database 210 that can store information used in managing the right to access a digital artwork including (but not limited to) digital edition ownership information 212 that includes at least one data entry made upon each sale or resale of a digital edition as further discussed below. In other embodiments, the digital edition database is stored on one or more separate computing devices. In various embodiments, the digital edition management server 202 includes a network interface 218 to communicate with other servers and artwork viewing devices connected via the Internet. In the illustrated embodiment, the memory 206 is a machine readable media that is utilized to store machine readable instructions that configure the processor 204.

The digital edition management application 208 can configure the processor 204 to query the digital edition database in controlling access to digital artworks. In many embodiments, the digital edition management application 208 creates a user interface to receive log-in credentials and authenticate a registered user with data stored in one or more tables within the digital edition database. Typically, a registered user is first authenticated before they can purchase digital editions and/or have access to previously purchased digital editions. Also, during a resale of previously purchased digital edition, the digital edition management server may first query the digital edition database to confirm that all generated digital editions of a digital artwork have been sold and the person attempting to resell the digital edition has ownership rights.

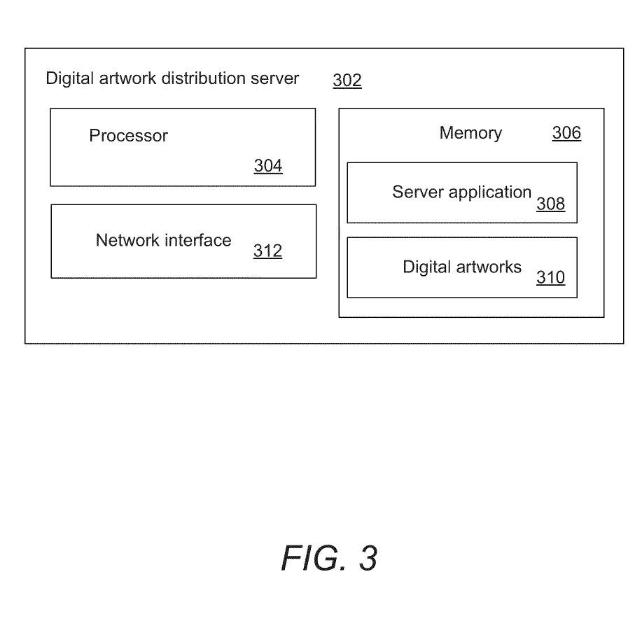

Digital artwork distribution servers can store and deliver digital artworks to registered users. A digital artwork distribution server in accordance with an embodiment of the invention is illustrated in FIG. 3. The digital artwork distribution server 302 includes a memory 306 that contains a server application 308 that configures the processor 304 to receive and store at least one digital artwork 310 in the memory 306 of the digital artwork distribution server. In many embodiments, the processor 304 further configures the processor 304 to deliver at least one digital artwork 310 to a registered user. In various embodiments, the digital artwork distribution server 302 includes a network interface 312 to connect to the Internet for distribution of digital artwork. Typically, once a digital edition of a digital artwork is purchased, an owner can stream the digital artwork from the digital art gallery server system and/or download and view the digital artwork independently of the digital art gallery server system. In further embodiments, the owner can send a download link of the digital artwork via email where the digital artwork can be accessed using one or more artwork viewing devices.

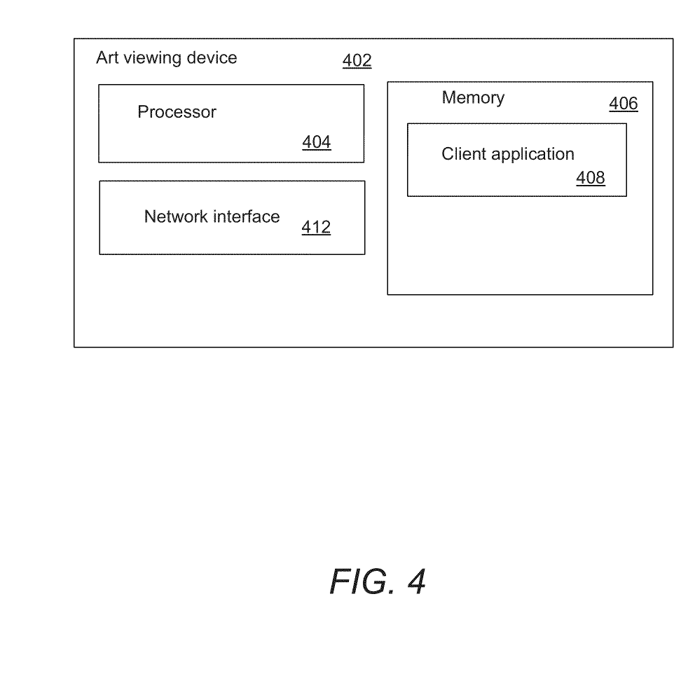

Various artwork viewing devices including (but not limited to) smart phones, smart televisions, laptops, desktops, and tablets can be utilized to receive and view digital artworks. An artwork viewing device in accordance with an embodiment of the invention is illustrated in FIG. 4. The artwork viewing device 402 includes a memory 406 that contains a client application 408 that configures a processor 404 to receive at least one digital artwork from a digital art gallery server system as discussed above. In many embodiments, the artwork viewing device 402 includes a network interface 412 to connect to the Internet. In various embodiments, an artwork viewing device can receive an entire collection of purchased digital artworks or create playlists to view selected digital artworks. In several embodiments, the digital art gallery server system can utilize digital rights management (DRM) schemes to protect against piracy and to further control usage rights to limited edition digital artworks. Art viewing devices can include image and/or video decoders that implement DRM using one or more DRM certificates (i.e. keys) to decode encrypted content received from the digital edition distribution server. In various embodiments, the digital art gallery server system can include a DRM server to implement various DRM schemes.

Although specific configurations of servers and artwork viewing devices are discussed above with respect to FIGS. 2-4, any of a variety of configurations of artwork viewing devices and servers can be utilized as appropriate to the requirements of a specific application in accordance with embodiments of the invention. Processes for distributing limited edition digital artworks in accordance with embodiments of the invention are further discussed below.

### Distribution of Limited Edition Digital Artwork

Digital artwork can be uploaded to a digital art gallery server system where a limited quantity of digital editions of the uploaded digital artwork can be generated. In many embodiments, the digital editions are sold to registered users thereby granting the purchaser access to download, stream and/or rent out the digital artwork. Typically, when a digital edition is sold, an entry is made in the digital edition database associating the purchasing registered user with a specific digital edition of the limited quantity of generated digital editions of a digital artwork signifying that the registered user is one of a limited number of users having the right to access the digital artwork. Stated another way, the user is not simply identified as having access to a particular piece of content but is granted a specific uniquely identifiable right to access the content and/or a specific copy of a particular piece of content. Under certain conditions, a registered user may resell her or his uniquely identifiable right to access a particular piece of content (i.e. their purchased digital edition) to another registered user. In many embodiments, another data entry is made in the digital database associating the registered user purchasing a digital edition at a resale signifying that the registered user is one of a limited number of users having the rights to access the digital artwork. In various embodiments, a chain of title to a digital edition can be ascertained from data entries made in the digital edition database upon sale and/or a resale of the digital edition.

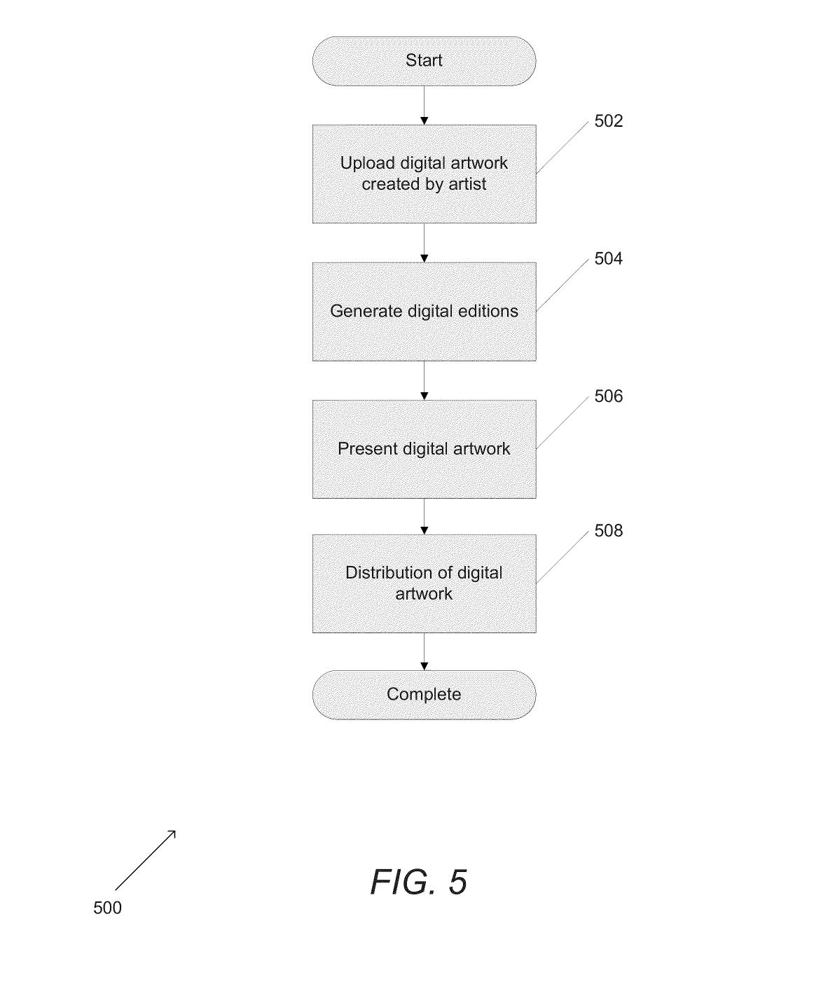

A process for distributing limited edition digital artwork in accordance with an embodiment of the invention is illustrated in FIG. 5. The process 500 includes uploading (502) a digital artwork created by an artist to the digital artwork distribution server digital art gallery server system where the digital artwork can include digital data and/or is created using digital techniques customarily used by artists that work with digital media. In many embodiments, the digital artwork is received and stored on the digital artwork distribution server. In several embodiments, a limited quantity of digital editions is generated (504) as further discussed below. In various embodiments, the digital artwork is presented (506) to a viewing audience to notify the public of limited edition digital artworks that can be purchased. In some embodiments, a visible and/or an imperceptible digital watermark can be applied to a digital edition making the digital edition unique. However, there is no requirement that the digital editions distributed to registered users be unique. In many embodiments, the limited number of users that can access digital editions is enforced by the digital art gallery server system. The process 500 also includes the distribution (508) of digital artwork that can further include activities such as (but not limited to) selling and reselling digital editions as further discussed below and the downloading, streaming, and/or renting out of a digital artwork. In various embodiments, a registered user can rent out digital artwork to another registered user thereby temporarily granting rights associated with ownership including (but not limited to) downloading and/or streaming of the digital artwork. In some embodiments, a rental fee can be charged generating revenue for a registered user or the revenue can be split between the registered user and the digital art gallery server system.

Although specific processes for distributing limited edition digital artwork are discussed above with respect to FIG. 5, any of a variety of processes for distributing limited edition digital artwork as appropriate to the requirements of a specific application can be utilized in accordance with embodiments of the invention. Processes for generating digital editions in accordance with embodiments of the invention are further discussed below.

### Generating Digital Editions of Uploaded Digital Artwork

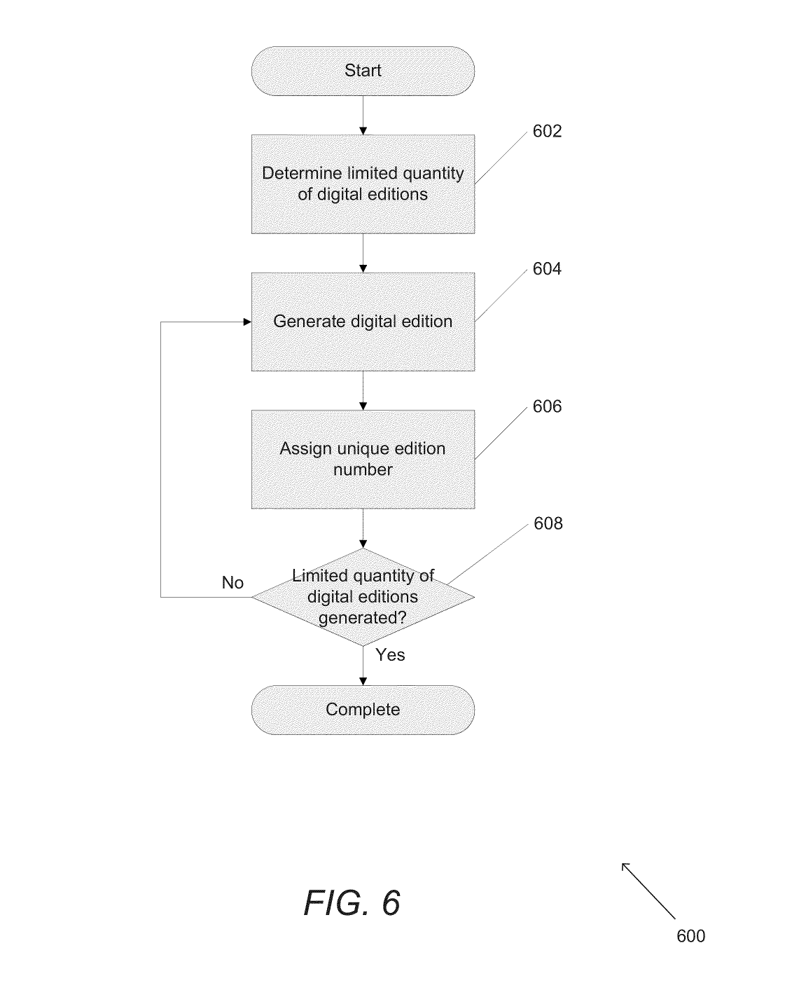

Although a digital edition can be a physical replica of a digital artwork, more typically, it is a data item in a digital edition database associating a digital artwork and a registered user. A process for generating digital editions of an uploaded digital artwork in accordance with an embodiment of the invention is illustrated in FIG. 6. The process 600 includes determining (602) a limited quantity of digital editions to generate of a particular digital artwork. In various embodiments, the quantity of digital editions can be determined using various inputs including feedback from the artist and/or third-parties, or any of a variety of data metrics associated with the digital artwork, artist, and/or viewing audience. The process 600 also includes generating (604) a digital edition and assigning (606) it a unique edition number. In many embodiments, the unique edition number is associated with a registered user upon sale of the digital edition as a data entry in the digital edition database indicating that the registered user has rights to access the uploaded digital artwork. In several embodiments, the process 600 further includes a determination (608) as to whether the limited quantity of digital editions has been generated. If the limited quantity has not been generated, another digital edition is generated (604) and assigned a unique edition number (606). If the determined limited quantity of digital editions has been generated, then the process 600 is complete.

Although specific processes for generating digital editions of uploaded digital artwork are discussed above with respect to FIG. 6, any of a variety of processes for generating digital editions as appropriate to the requirements of a specific application can be utilized in accordance with embodiments of the invention. Processes for the sale of limited edition digital artworks in accordance with embodiments of the invention are further discussed below.

### Initial Sale of Limited Edition Digital Artworks

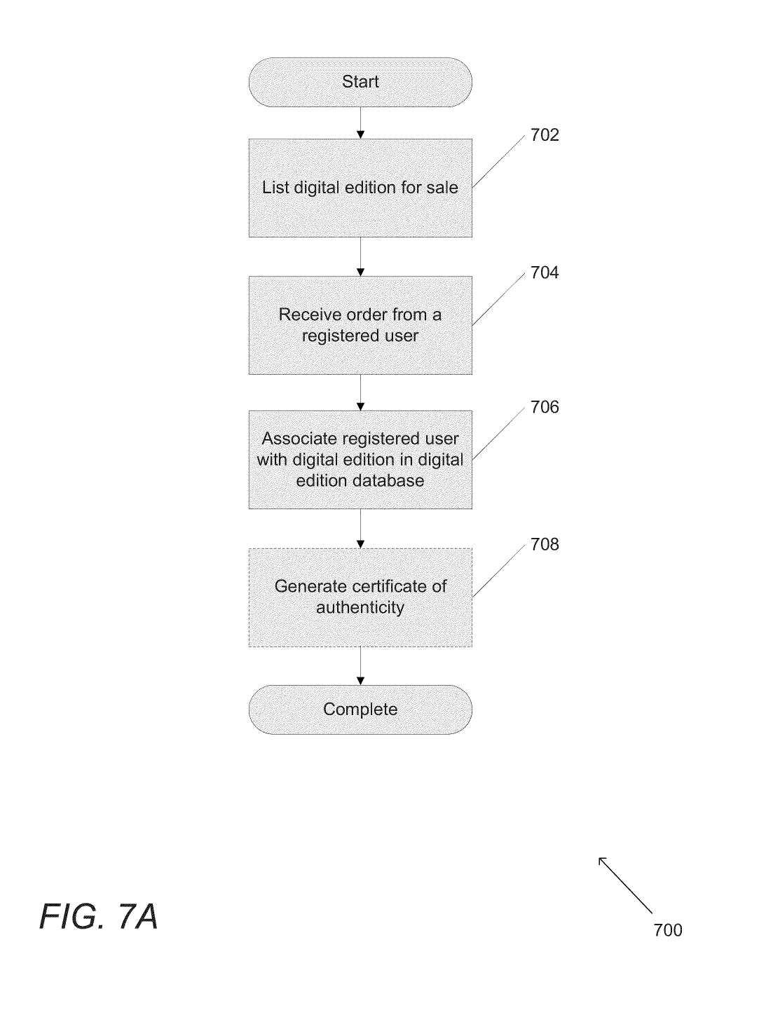

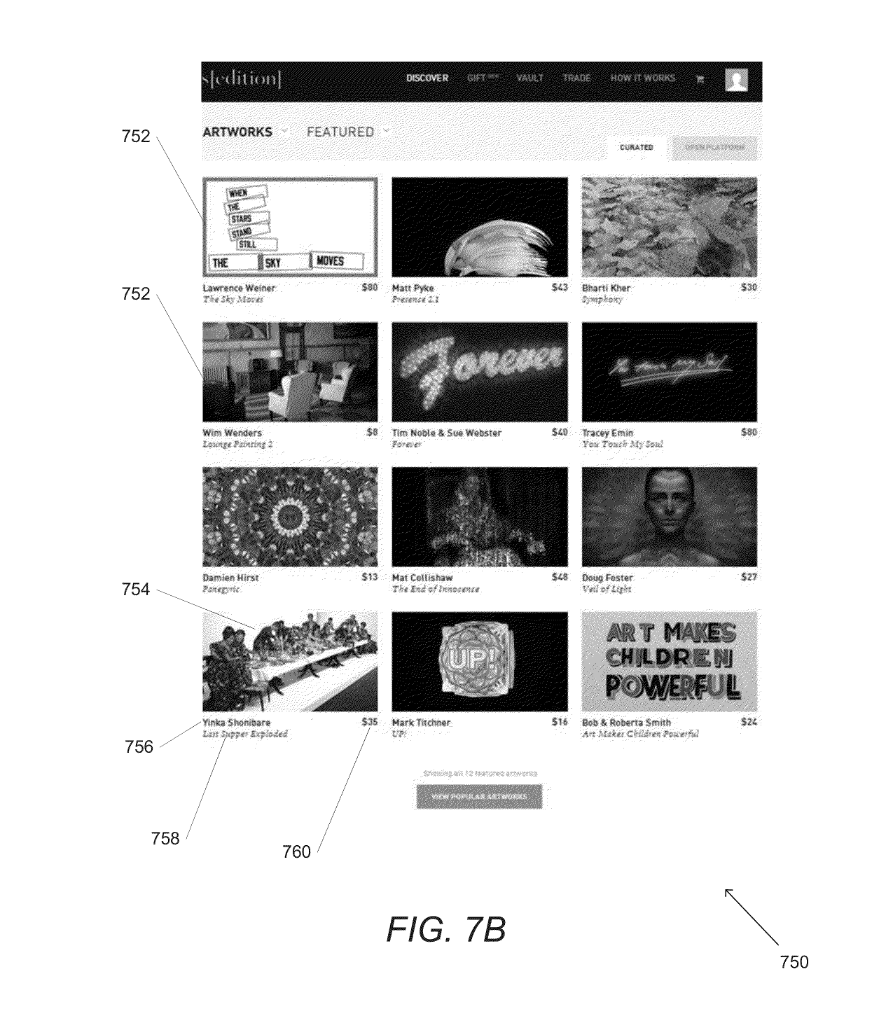

As discussed above, ownership of a digital edition of a digital artwork can grant access to a registered user to stream, download, sell, and/or rent out the digital artwork. A process by which a digital edition of a digital artwork can be initially listed for sale and sold via a digital art gallery server system in accordance with an embodiment of the invention is illustrated in FIG. 7A. The process 700 includes listing (702) a digital edition for sale on the digital art gallery server system. In several embodiments, a purchase order is received (704) from a registered user along with payment via a credit card, gift card, or any other viable method of online payment. In some embodiments, a registered user may purchase a digital edition as a gift for another person. Typically, listing data is stored in the digital edition database including (but not limited to) a unique listing identification number, a digital artwork's identification number, edition identification number, offer price information, and purchase information. In many embodiments, a data entry is made associating (706) a registered user with the digital edition in the digital edition database indicating that the registered user is entitled to access rights associated with ownership of a digital edition. Also, a certificate of authenticity indicating proof of ownership may be generated (708) that includes the edition number, title of the digital artwork, name of the artist, date of purchase, name of purchaser, artist and/or digital art gallery signatures.

An example of a user interface that can be generated in accordance with an embodiment of the invention is shown in FIG. 7B. A screen shot 750 of the user interface illustrates listing digital editions for sale using multiple thumbnails 752 where each thumbnail can include a still image 754 of the digital artwork, artist name 756, digital artwork title 758, and list price 760. Registered users may find listings of digital editions for sale by browsing categories of digital artworks including (but not limited to) featured, most popular, new releases, last remaining, alphabetically by title, price, and/or media type. Digital editions may also be categorized for sale by the artists including (but not limited to) the latest artist, most collected, most followed, and/or alphabetically by artist names.

Although specific processes for the initial listing and sale of limited edition digital artworks are discussed above with respect to FIGS. 7A-B, any of a variety of processes for selling limited edition digital artworks as appropriate to the requirements of a specific application can be utilized in accordance with embodiments of the invention. Processes for the resale of limited edition digital artworks in accordance with embodiments of the invention are further discussed below.

### Resale of Limited Edition Digital Artworks

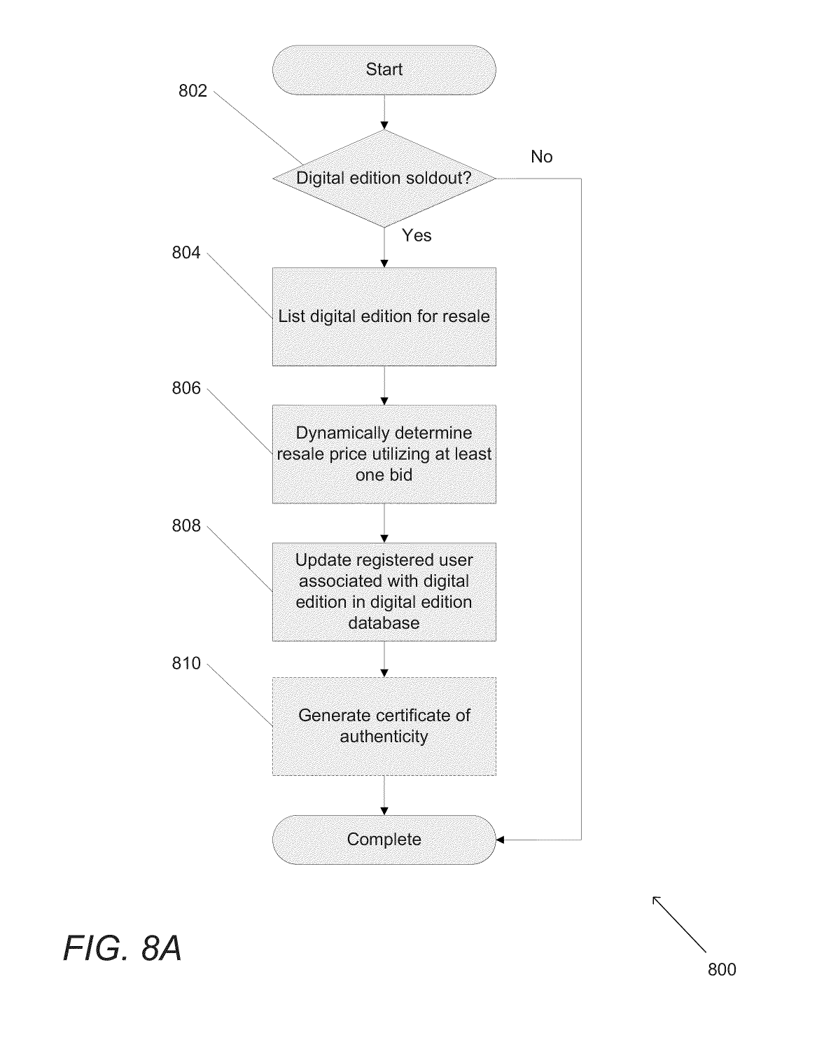

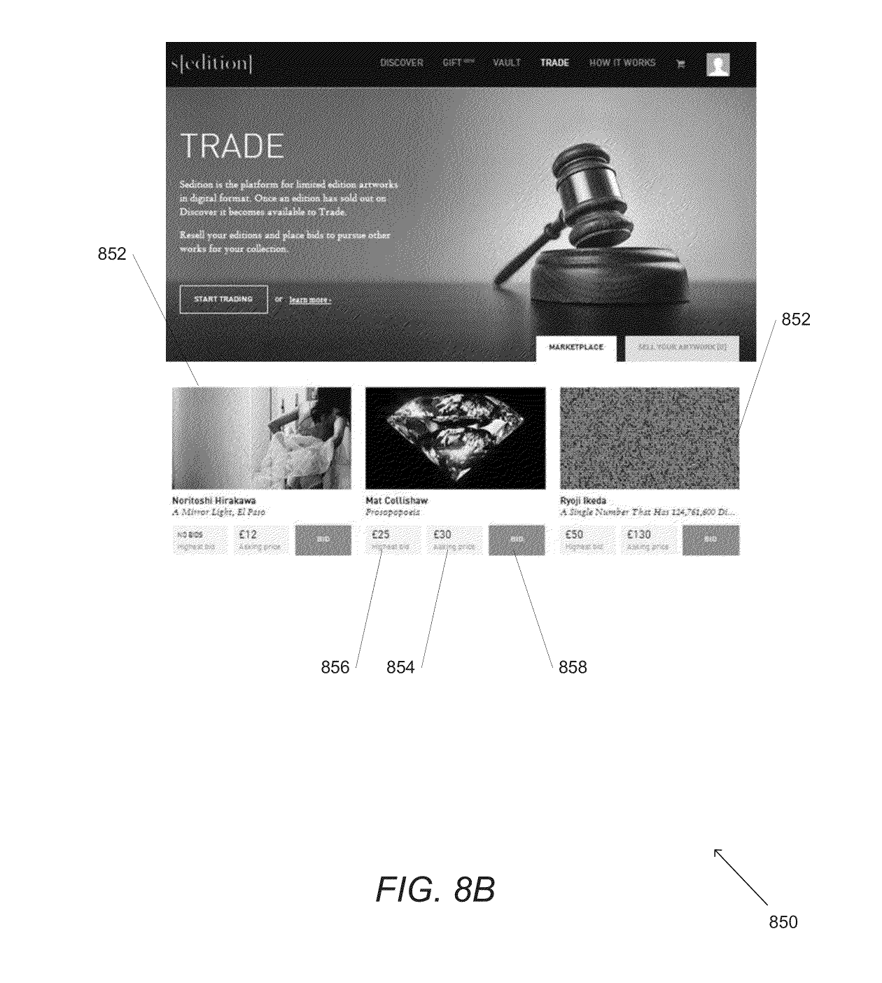

Previously purchased digital editions of digital artworks may be resold to other registered users if certain conditions are met such as (but not limited to) all generated digital editions are sold out and/or a determined amount of time has lapsed since the last digital edition was sold. A process for the resale of previously purchased digital editions of digital artworks in accordance with an embodiment of the invention is illustrated in FIG. 8A. The resale process 800 includes determining (802) whether all of the generated digital editions of a digital artwork have been sold as discussed above. If all digital editions have not been sold, then resale is not allowed and the process 800 is complete. However, if all digital editions have been sold, then resale of a digital edition is allowed. If resale is allowed, a registered user with ownership rights to a digital edition can list (804) the digital edition for resale to the digital art gallery server system as discussed above. In many embodiments, registered users can place bids (806) on a digital edition indicating the price they are willing to pay to purchase the digital edition. In several embodiments, the biding process can be structured so that subsequent bids are greater than previously submitted bids and/or where subsequent bids are incrementally increased from previous bids. In many embodiments, the highest bidder wins the bidding process and becomes the new owner of the digital edition (with transfer of payment). In various embodiments, the new owner is now granted access rights to the limited edition digital artwork.

Typically, data entries related to the resale are made in the digital edition database including (but not limited to) seller's identification, buyer's identification, edition identification, and/or winning bid. In various embodiments, data entries are also made in the digital edition database tracking bids including bidder identification, artwork identification, edition identification, price information including bid amount and currency type, and when the bids were placed and/or updated. Further, a data entry is entered in the digital edition database updating (808) the registered user associated with the specific digital edition of the digital artwork, where the association in the digital edition database signifies that the new registered user is one of a limited number of users having the right to access the digital artwork. In various embodiments, the data entry updating ownership extinguishes the previous owner's rights. In some embodiments, a new certificate of authenticity indicating proof of ownership can be generated (810) at the time of resale or generated upon request at a later time. In many embodiments, a chain of title of ownership to a digital edition can be queried from the digital edition database and generated using data entries made during each sale and/or resale of a digital edition that associates the digital edition to a registered user at the time of the respective sale and/or resale.

An example of a user interface that can be generated in accordance with an embodiment of the invention is shown in FIG. 8B. A screen shot 850 of the user interface illustrates listing digital editions for resale using multiple thumbnails 852. In many embodiments, the listing can indicate an asking price 854 that the seller is willing to accept for immediately transferring ownership of the digital edition. In several embodiments, the listing can also include the current highest bid 856 and a link 858 that allows registered users to place additional bids. In various embodiments, prospective buyers can browse digital editions available for resale by searching categories including (but not limited) digital artworks, artists, titles, highest bids, and/or asking prices.

Although specific processes for the resale of limited edition digital artworks are discussed above with respect to FIGS. 8A-B, any of a variety of processes for reselling limited edition digital artwork as appropriate to the requirements of a specific application can be utilized in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A digital art gallery server system comprising:
a digital edition distribution server comprising:
a processor; and
a memory containing:
a digital edition distribution server application; and
a plurality of files containing digital artworks;
wherein the digital edition distribution server application configures the processor to:
receive a request to access at least one file containing a digital artwork from a user; and
transmit data within the at least one file containing the digital artwork to the user;
a digital edition database containing data describing:
the digital artworks stored on the digital edition distribution server;
a plurality of user accounts;
the digital artworks specific user accounts are authorized to access; and
associations between digital edition entries referencing specific digital artworks and specific user accounts; and
a digital edition management server configured to communicate with the digital edition distribution server comprising:
a processor; and
a memory containing a digital edition management server application;
wherein the digital edition management server application configures the processor to:
generate a limited number of digital edition entries within the digital edition database referencing the digital artworks stored in the digital distribution server, where each digital edition entry in the digital edition database includes an edition number that uniquely identifies each digital edition;
generate a user interface that includes information regarding at least one digital edition for sale, where the user interface allows the digital edition management server to receive a request to purchase the at least one digital edition for sale;
associate a specific digital edition entry in the digital edition database with a specific user account upon the sale of each digital edition reflecting a chain of title indicating ownership to the sold digital edition;
identify at least one digital artwork that a specific user account is authorized to access from the data describing the digital artworks specific user accounts are authorized to access in the digital edition database; and
generate a user interface that provides information for requesting access to at least one file containing the digital artwork.

2. The digital art gallery server system of claim 1, wherein the digital edition database utilizes a relational data model.

3. The digital art gallery server system of claim 1, wherein the digital edition management server application further configures the processor to receive log-in credentials and authenticate the log-in credentials with the plurality of user accounts stored in the digital edition database.

4. The digital art gallery server system of claim 3, wherein the digital edition management server application further configures the processor to generate a user interface that includes information regarding at least one digital edition for resale, where the user interface allows the digital edition management server to receive a request to purchase the at least one digital edition for resale.

5. The digital art gallery server system of claim 4, wherein the resale of the at least one digital edition further comprises confirming that all the generated limited number of digital edition entries referencing the specific digital artwork have been associated with specific user accounts.

6. The digital art gallery server system of claim 4, wherein the resale of the at least one digital edition includes an auction process, where the auction process comprises receiving at least one bid via the user interface to purchase the at least one digital edition for resale.

7. The digital art gallery server system of claim 4, wherein:
the digital edition database further comprises data describing associations between digital edition entries referencing specific digital artworks and specific user accounts forming chains of title for the specific digital editions; and
the digital edition management server application further configures the processor to associate a specific digital edition entry in the digital edition database with a specific user account upon the resale of each digital edition reflecting a chain of title to the resold digital edition.

8. The digital art gallery server system of claim 3, wherein:
the digital edition database further comprises data describing rental permissions with respect to specific digital edition entries and specific user accounts; and
the digital edition management server application further configures the processor to receive a rental request to access at least one file containing a digital artwork.

9. The digital art gallery server system of claim 8, wherein the digital edition management server application further configures the processor to conduct a financial transaction that provides credits to the user account associated with the digital edition entry granted rental permissions.

10. The digital art gallery server system of claim 9, wherein the digital edition management server application further configures the processor to determine an amount to credit to the user account associated with the digital edition entry granted rental permissions and an amount to credit an account associated with the digital art gallery server system, where the account associated with the digital art gallery server system is stored in the digital edition database.

11. The digital art gallery server system of claim 1, wherein the data describing the digital artworks specific user accounts are authorized to access is the associations between digital edition entries referencing specific digital artworks and specific user accounts.

12. A method for distributing limited edition digital artwork, the method comprising:
receiving a request to access at least one file containing a digital artwork from a user using a digital edition distribution server, where the digital edition distribution server comprises a memory containing a plurality of files containing digital artworks;
transmitting the data within at least one file containing the digital artwork to the user using the digital edition distribution server;
generating a limited number of digital edition entries within a digital edition database referencing the digital artworks stored in the digital distribution server using a digital edition management server, where each digital edition entry in the digital edition database includes an edition number that uniquely identifies each digital edition and the digital edition database contains data describing:
the digital artworks stored on the digital edition distribution server;
a plurality of user accounts;
the digital artworks specific user accounts are authorized to access; and
associations between digital edition entries referencing specific digital artworks and specific user accounts;
generating a user interface that includes information regarding at least one digital edition for sale using the digital edition management server, where the user interface allows the digital edition management server to receive a request to purchase the at least one digital edition for sale;
associating a specific digital edition entry in the digital edition database with a specific user account upon the sale of each digital edition reflecting a chain of title indicating ownership to the sold digital edition using the digital edition management server;
identifying at least one digital artwork that a specific user account is authorized to access from the data describing the digital artworks specific user accounts are authorized to access in the digital edition database using the digital edition management server; and
generating a user interface that provides information for requesting access to at least one file containing the digital artwork using the digital edition management server.

13. The method of claim of 12, wherein the digital edition database utilizes a relational data model.

14. The method of claim 12, further comprising receiving log-in credentials and authenticating the log-in credentials with the plurality of user accounts stored in the digital edition database using the digital edition management server.

15. The method of claim 14, further comprising generating a user interface that includes information regarding at least one digital edition for resale using the digital edition management server, where the user interface allows the digital edition management server to receive a request to purchase the at least one digital edition for resale.

16. The method of claim 15, wherein the resale of the at least one digital edition further comprises confirming that all the generated limited number of digital edition entries referencing the specific digital artwork have been associated with specific user accounts.

17. The method of claim 15, wherein the resale of the at least one digital edition includes an auction process, where the auction process comprises receiving at least one bid via the user interface to purchase the at least one digital edition for resale.

18. The method of claim 15, further comprising associating a specific digital edition entry in the digital edition database with a specific user account upon the resale of each digital edition reflecting a chain of title to the resold digital edition, wherein the digital edition database further comprises data describing associations between digital edition entries referencing specific digital artworks and specific user accounts forming chains of title for the specific digital editions.

19. The method of claim 14, further comprising receiving a rental request to access at least one file containing a digital artwork, wherein the digital edition database further comprises data describing rental permissions with respect to specific digital edition entries and specific user accounts.

20. The method of claim 19, further comprising conducting a financial transaction that provides credits to the user account associated with the digital edition entry granted rental permissions.

21. The method of claim 20, further comprising determining an amount to credit to the user account associated with the digital edition entry granted rental permissions and an amount to credit an account associated with the digital art gallery server system, where the account associated with the digital art gallery server system is stored in the digital edition database.

22. The method of claim 12, wherein the data describing the digital artworks specific user accounts are authorized to access is the associations between digital edition entries referencing specific digital artworks and specific user accounts.
